(19) United States
(12) Patent Application Publication
(10) Pub. No.: US 2016/0297292 A1
(43) Pub. Date: Oct. 13, 2016

(54) VEHICLE

(71) Applicant: Toyota Jidosha Kabushiki Kaisha, Toyota-shi Aichi-ken (JP)

(72) Inventors: Shun Sato, Toyota-shi Aichi-ken (JP); Toshio Sugimura, Nagoya-shi Aichi-ken (JP); Takahiko Tsutsumi, Nisshin-shi Aichi-ken (JP)

(21) Appl. No.: 15/094,126

(22) Filed: Apr. 8, 2016

(30) Foreign Application Priority Data
Apr. 10, 2015 (JP) 2015-080727

(51) Int. Cl. B60K 6/54; B60K 6/26; B60K 6/387

(52) U.S. Cl. CPC B60K 6/54; B60K 6/387; B60K 6/26; Y10S 903/914; Y10S 903/917; Y10S 903/906; B60Y 2200/92; B60Y 2300/426; B60Y 2400/406; B60Y 2400/785

(57) ABSTRACT

A motor disconnect clutch is configured to be set to an engaged state when a hydraulic pressure that is supplied from a mechanical oil pump (MOP) is lower than a predetermined release hydraulic pressure, and be set to a released state when the hydraulic pressure that is supplied from the MOP is higher than or equal to the release hydraulic pressure. When the hydraulic pressure output from the MOP is likely to decrease to a hydraulic pressure lower than the release hydraulic pressure in an engine mode in which the vehicle travels by using power of the engine while the motor disconnect clutch is placed in the released state, an ECU executes synchronization control for synchronizing a rotation speed of a motor generator with a rotation speed of a rotary shaft.

### CROSS-REFERENCE TO RELATED APPLICATIONS

The present disclosure claims priority to Japanese Patent Application No. 2015-080727 filed on Apr. 10, 2015 which is incorporated herein by reference in its entirity including the specification, drawings and abstract.

### BACKGROUND

1. Technical Field

The present disclosure relates to a vehicle including an engine and a motor generator.

2. Description of Related Art

Japanese Patent Application Publication No. 2009-35128 (JP 2009-35128 A) describes a hybrid vehicle including an engine, an automatic transmission and a motor generator. The automatic transmission is provided between the engine and drive wheels. The motor generator is connected to an output shaft of the automatic transmission. In this hybrid vehicle, a clutch is provided between the output shaft of the automatic transmission and the motor generator. The clutch is used to disconnect the motor generator from the output shaft of the automatic transmission.

### SUMMARY

In the vehicle described in JP 2009-35128 A, when the motor disconnect clutch is a normally-closed clutch and a hydraulic pressure supply source for the motor disconnect clutch is a mechanical oil pump that is driven by the rotation of the engine, if the output power of the mechanical oil pump rapidly decreases as a result of engine stall in a mode in which the vehicle travels by using the power of the engine while releasing the motor disconnect clutch, the motor disconnect clutch may be unexpectedly engaged. The normally-closed clutch is engaged in a normal state where no hydraulic pressure is supplied, and is released in a state where hydraulic pressure higher than or equal to a predetermined release hydraulic pressure is supplied. At this time, when there is a difference between the rotation speed of the motor generator and the output shaft rotation speed of the automatic transmission, shock occurs at the time when the motor disconnect clutch is engaged.

The present disclosure prevents or reduces shock even when a motor disconnect clutch is unexpectedly engaged.

A vehicle according to an embodiment of the present disclosure includes an engine, a motor generator connected to a power transmission path between the engine and a drive wheel, an oil pump connected to a rotary shaft provided in the power transmission path between the engine and the drive wheel, the oil pump being configured to be driven by rotation of the rotary shaft, a motor disconnect clutch provided between the motor generator and the power transmission path between the engine and the drive wheel, the motor disconnect clutch being configured to operate by using hydraulic pressure that is supplied to the oil pump, and a controller configured to control the motor generator. The motor disconnect clutch is configured to be set to an engaged state when the hydraulic pressure that is supplied from the oil pump is lower than a predetermined release hydraulic pressure, and be set to a released state when the hydraulic pressure that is supplied from the oil pump is higher than or equal to the release hydraulic pressure. The controller is configured to, when the hydraulic pressure output from the oil pump is likely to decrease to a hydraulic pressure lower than the release hydraulic pressure during execution of control for releasing the motor disconnect clutch, execute synchronization control for synchronizing a rotation speed of the motor generator with a rotation speed of the rotary shaft.

With the above configuration, when the hydraulic pressure output from the oil pump is likely to decrease to a hydraulic pressure lower than the release hydraulic pressure during execution of the control for releasing the motor disconnect clutch, the rotation speed of the motor generator is synchronized with the rotation speed of the rotary shaft through synchronization control. Therefore, even when the hydraulic pressure output from the oil pump decreases to a hydraulic pressure lower than the release hydraulic pressure thereafter and the motor disconnect clutch is engaged, shock is prevented or reduced because the rotation speed of the motor generator is synchronized with the rotation speed of the rotary shaft.

The controller may be configured to, when a brake operation amount of a user exceeds a threshold amount during execution of the control for releasing the motor disconnect clutch, determine that the hydraulic pressure output from the oil pump is likely to decrease to a hydraulic pressure lower than the release hydraulic pressure and execute the synchronization control.

With the above configuration, when the brake operation amount exceeds the threshold amount during execution of the control for releasing the motor disconnect clutch, the rotation speed of the motor generator is synchronized with the rotation speed of the rotary shaft through synchronization control. Therefore, if the rotation speed of the engine decreases as a result of a decrease in vehicle speed due to sudden brake, the hydraulic pressure output from the oil pump decreases with a decrease in the rotation speed of the engine and then the motor disconnect clutch is engaged, shock is prevented or reduced.

The vehicle may further include an automatic transmission provided between the engine and the drive wheel, and a torque converter. The torque converter may include a pump impeller connected to the engine, a turbine runner connected to an input shaft of the automatic transmission, and a lockup clutch. The rotary shaft may be provided in a power transmission path that connects the engine to the torque converter. The controller may be configured to, when there occurs a stuck-on failure, determine that the hydraulic pressure output from the oil pump is likely to decrease to a hydraulic pressure lower than the release hydraulic pressure and execute synchronization control. The stuck-on failure may be a state where the lockup clutch is engaged in a state where the lockup clutch is controlled to a released state and a rotation speed of the turbine runner is lower than a rotation speed of the engine.

With this configuration, when there occurs a stuck-on failure of the lockup clutch in a state where the lockup clutch is controlled to the released state and the rotation speed of the turbine runner is lower than the rotation speed of the engine during execution of the control for releasing the motor disconnect clutch, the rotation speed of the motor generator is synchronized with the rotation speed of the rotary shaft through synchronization control. Therefore, if the rotation speed of the engine is influenced by the rotation speed of the turbine runner and decreases due to a stuck-on failure of the lockup clutch, the hydraulic pressure output from the oil pump decreases with a decrease in the rotation speed of the engine and then the motor disconnect clutch is engaged, shock is prevented or reduced.

The vehicle may further include a hydraulic pressure sensor configured to detect the hydraulic pressure output from the oil pump. The controller may be configured to, when a value detected by the hydraulic pressure sensor has decreased to a hydraulic pressure lower than a threshold pressure higher by a predetermined value than the release hydraulic pressure during execution of the control for releasing the motor disconnect clutch, determine that the hydraulic pressure output from the oil pump is likely to decrease to a hydraulic pressure lower than the release hydraulic pressure and execute the synchronization control.

With this configuration, when the hydraulic pressure output from the oil pump and detected by the hydraulic pressure sensor has decreased a hydraulic pressure lower than a threshold pressure higher by a predetermined value than the release hydraulic pressure during execution of the control for releasing the motor disconnect clutch, the rotation speed of the motor generator is synchronized with the rotation speed of the rotary shaft through synchronization control. Therefore, even when the hydraulic pressure output from the oil pump decreases to a hydraulic pressure lower than the release hydraulic pressure thereafter and the motor disconnect clutch is engaged, shock is prevented or reduced.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an overall configuration view of a vehicle;

FIG. 2 is a timing chart that shows a comparative embodiment;

FIG. 3 is a flowchart that shows the procedure of an ECU;

FIG. 4 is a timing chart that shows an example of changes in MG rotation speed Nm, and the like, in the case where a user applies rapid brake in engine drive mode; and

FIG. 5 is a timing chart that shows an example of changes in MG rotation speed Nm, and the like, in the case where there occurs a stuck-on failure of a lockup clutch in engine drive mode.

### DETAILED DESCRIPTION OF EMBODIMENTS

Hereinafter, an embodiment of the present disclosure will be described in detail with reference to the accompanying drawings. Like reference numerals denote the same or corresponding portions in the drawings, and the description thereof will not be repeated.

### Overall Configuration of Vehicle

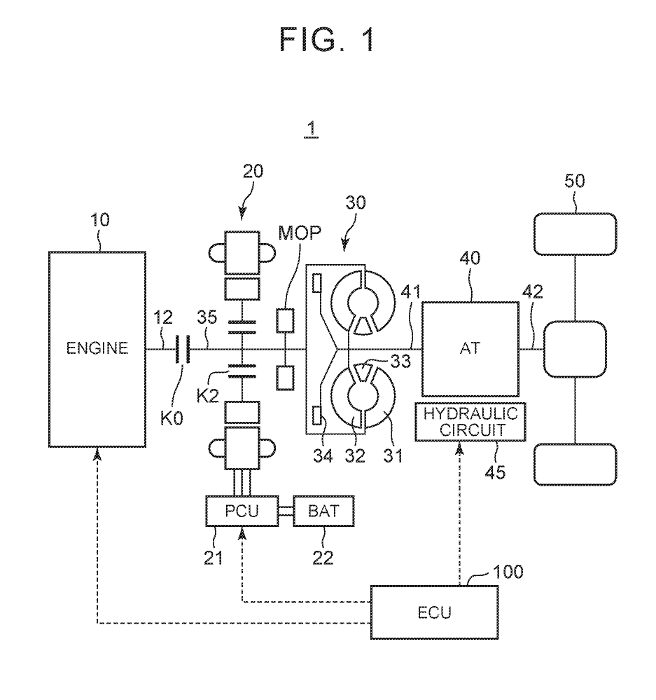

FIG. 1 is an overall configuration view of a vehicle 1 according to the present embodiment. The vehicle 1 includes an engine 10, a motor generator (hereinafter, also referred to as MG) 20, a power control circuit (hereinafter, referred to as power control unit (PCU)) 21, a battery 22, a torque converter 30, an automatic transmission 40, a hydraulic circuit 45, drive wheels 50, an engine disconnect clutch K0 (hereinafter, also simply referred to as clutch K0), an MG disconnect clutch K2 (hereinafter, also simply referred to as clutch K2), and an electronic control unit (ECU) 100.

The vehicle 1 is a hybrid vehicle that travels by using the power of at least one of the engine 10 and the MG 20.

A crankshaft 12 of the engine 10 is connected to a rotary shaft 35 via the clutch K0. The rotor of the MG 20 is connected to the rotary shaft 35 via the clutch K2.

The rotary shaft 35 is connected to an input shaft 41 of the automatic transmission 40 via the torque converter 30. An output shaft 42 of the automatic transmission 40 is connected to the drive wheels 50.

In the present embodiment, the MG 20 is connected to the rotary shaft 35 provided in a power transmission path that connects the engine 10 to the torque converter 30. Instead, the MG 20 does not need to be necessarily connected to the rotary shaft 35 as long as the MG 20 is connected in the power transmission path between the engine 10 and the drive wheels 50. For example, the MG 20 may be connected to the output shaft 42 of the automatic transmission 40.

The engine 10 is an internal combustion engine, such as a gasoline engine and a diesel engine. The MG 20 is driven by high-voltage electric power that is supplied from the battery 22 via the PCU 21. The MG 20 generates electric power as the MG 20 is rotated by power that is transmitted from the rotary shaft 35 (power that is transmitted from the engine 10 or the drive wheels 50).

The battery 22 stores electric power to be supplied to the MG 20. The PCU 21 converts electric power between the MG 20 and the battery 22.

The torque converter 30 includes a pump impeller 31, a turbine runner 32, a stator 33 and a lockup clutch 34. The lockup clutch 34 is controlled to any one of an engaged state (lockup-on control state), a released state (lockup-off control state) and a half-engaged state (flex control state) on the basis of a control signal from the ECU 100.

When the lockup clutch 34 is in the engaged state, the pump impeller 31 and the turbine runner 32 rotate integrally with each other. When the lockup clutch 34 is in the released state, power is transmitted by hydraulic oil between the pump impeller 31 and the turbine runner 32, so there can be a rotation speed difference between the pump impeller 31 and the turbine runner 32 (a slip of the torque converter 30).

When the lockup clutch 34 is in the half-engaged state, power is transmitted by hydraulic oil and the lockup clutch 34 between the pump impeller 31 and the turbine runner 32. Therefore, there can be a rotation speed difference between the pump impeller 31 and the turbine runner 32; however, the difference is smaller than that in the case where the lockup clutch 34 is in the engaged state.

The automatic transmission 40 is a stepped automatic transmission that is able to selectively establish a plurality of gear positions having different speed ratios (the ratios of the rotation speed of the input shaft 41 to the rotation speed of the output shaft 42).

A mechanical oil pump MOP is connected to the rotary shaft 35. The mechanical oil pump MOP operates as the rotary shaft 35 rotates. When the mechanical oil pump MOP operates, the mechanical oil pump MOP draws hydraulic oil stored in an oil pan (not shown) and then discharges the hydraulic oil to the hydraulic circuit 45. Although not shown in FIG. 1, an electric oil pump may be provided in addition to the mechanical oil pump MOP.

The hydraulic circuit 45 regulates the output hydraulic pressure of the mechanical oil pump MOP (hereinafter, also referred to as MOP pressure) to a predetermined constant hydraulic pressure (line pressure). The hydraulic circuit 45 regulates hydraulic pressure that is supplied to the clutch K0 (K0 pressure), hydraulic pressure that is supplied to the clutch K2 (K2 pressure) and hydraulic pressure that is supplied to the lockup clutch 34 (LU pressure) by using the line pressure as a source pressure in response to control signals from the ECU 100.

The clutch K2 according to the present embodiment is so-called normally-closed (hereinafter, also referred to as N/C) clutch. That is, the clutch K2 is configured to be set to an engaged state when the K2 pressure that is supplied from the mechanical oil pump MOP via the hydraulic circuit 45 is lower than a predetermined release hydraulic pressure P1, and be set to a released state when the K2 pressure is higher than or equal to the predetermined release hydraulic pressure P1. By employing the N/C clutch as the clutch K2, even in a state where the rotary shaft 35 is not rotating (state where the mechanical oil pump MOP is not operating), the clutch K2 is placed in the engaged state, so the power of the MG 20 is transmitted to the rotary shaft 35.

The clutch K0 according to the present embodiment, as well as the clutch K2, is an N/C clutch. The clutch K0 may be a so-called normally-open clutch. The normally-open clutch is set to a released state when supplied hydraulic pressure is lower than a predetermined engagement pressure, and is set to an engaged state when supplied hydraulic pressure is higher than or equal to the predetermined engagement pressure.

The vehicle 1 includes a plurality of sensors (all of which are not shown) for detecting physical quantities that are required to control the vehicle 1. The physical quantities that are required to control the vehicle 1 include an accelerator pedal operation amount (accelerator operation amount) by a user, a brake pedal operation amount (brake depression force) by the user, a vehicle speed, a rotation speed of the engine 10 (hereinafter, also referred to as engine rotation speed Ne), a rotation speed of the MG 20 (hereinafter, also referred to as MG rotation speed Nm), a rotation speed of the rotary shaft 35, a rotation speed of the turbine runner 32 (hereinafter, also referred to as turbine rotation speed Nt), a shift position, and the like. These sensors transmit detected results to the ECU 100.

The ECU 100 includes a central processing unit (CPU) (not shown) and a memory (not shown). The ECU 100 executes predetermined computations on the basis of information from the sensors and information stored in the memory, and controls devices of the vehicle 1 on the basis of the computed results.

The ECU 100 causes the vehicle 1 to travel in any one of a motor mode, a hybrid mode and an engine mode. In the motor mode, the ECU 100 causes the rotary shaft 35 to be rotated by the power of the MG 20 by engaging the clutch K2 and releasing the clutch K0. In the hybrid mode, the ECU 100 causes the rotary shaft 35 to be rotated by the power of at least one of the engine 10 and the MG 20 by engaging the clutch K2 and engaging the clutch K0. In the engine mode, the ECU 100 causes the rotary shaft 35 to be rotated by the power of the engine 10 by releasing the clutch K2 and engaging the clutch K0.

### Nm Synchronization Control

In the vehicle 1 having the above-described configuration, when stall of the engine 10 occurs and the rotation speed of the rotary shaft 35 rapidly decreases in engine mode (while control for releasing the clutch K2 by setting the K2 pressure to a hydraulic pressure higher than or equal to the release hydraulic pressure P1 is being executed), there is a concern that the clutch K2 is unexpectedly engaged and shock occurs.

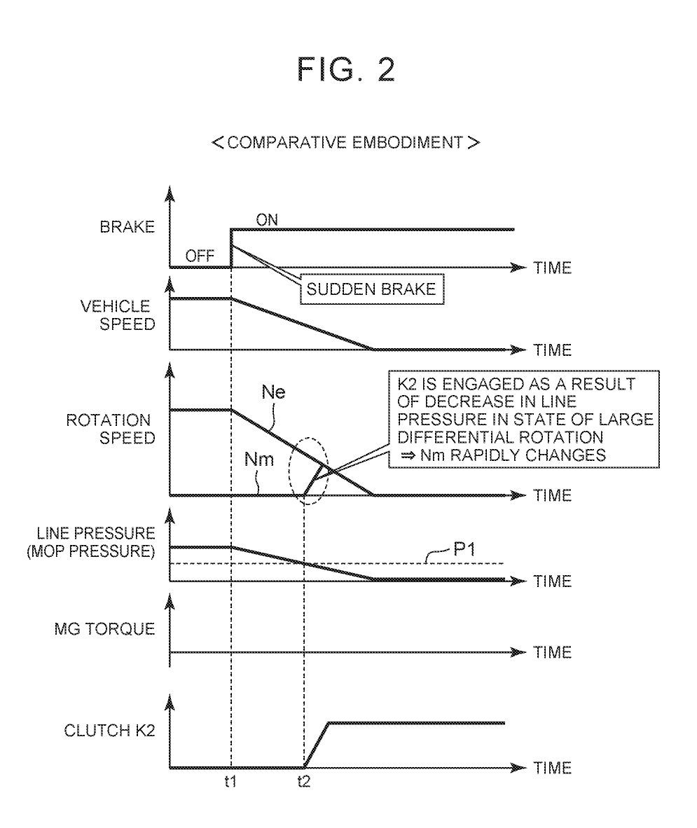

FIG. 2 is a timing chart that shows an example of change in MG rotation speed Nm, and the like, in the case where shock occurs as a result of rapid brake of the user in engine mode as a comparative embodiment to the present embodiment.

Before time t1, the vehicle 1 is traveling in engine mode. That is, the K2 pressure is controlled to a hydraulic pressure higher than or equal to the release hydraulic pressure P1 of the clutch K2, and the clutch K2 is released. The clutch K0 is engaged, and the engine 10 is connected to the drive wheels 50.

When the user suddenly brakes the vehicle and, as a result, the vehicle speed rapidly decreases at time t1, the engine rotation speed Ne also rapidly decreases with a rapid decrease in the vehicle speed, and, at last, the engine 10 stalls. Therefore, the rotation speed of the rotary shaft 35 also rapidly decreases, and the MOP pressure rapidly decreases. In accordance with this, as the line pressure decreases to a hydraulic pressure lower than the release hydraulic pressure P1 of the clutch K2, the K2 pressure that uses the line pressure as the source pressure also decreases to the hydraulic pressure lower than the release hydraulic pressure P1, so the N/C clutch K2 is unexpectedly engaged. Just before the clutch K2 is engaged, the MG 20 is stopped and the MG rotation speed Nm is zero; however, the rotation speed of the rotary shaft 35 has not yet decreased to zero, so there is a difference between the MG rotation speed Nm and the rotation speed of the rotary shaft 35. For this reason, at the time when the clutch K2 is engaged, the MG rotation speed Nm rapidly changes toward the rotation speed of the rotary shaft 35, and there occurs shock (engagement shock) due to inertia energy.

In order to eliminate such a problem, the ECU 100 determines whether the MOP pressure is likely to decrease to a hydraulic pressure lower than the release hydraulic pressure P1 of the clutch K2 in engine mode on the basis of a vehicle state. When the ECU 100 determines that the MOP pressure is likely to decrease to a hydraulic pressure lower than the release hydraulic pressure P1 of the clutch K2, the ECU 100 executes the process of executing feedback control over the torque of the MG 20 such that the MG rotation speed Nm is synchronous with the engine rotation speed Ne (the rotation speed of the rotary shaft 35) (hereinafter, also referred to as Nm synchronization control). Thus, if the clutch K2 is unexpectedly engaged due to a decrease in the MOP pressure, the difference between the MG rotation speed Nm and the engine rotation speed Ne is extremely small, and the MG rotation speed Nm does not rapidly change, so the above-described engagement shock is prevented or reduced.

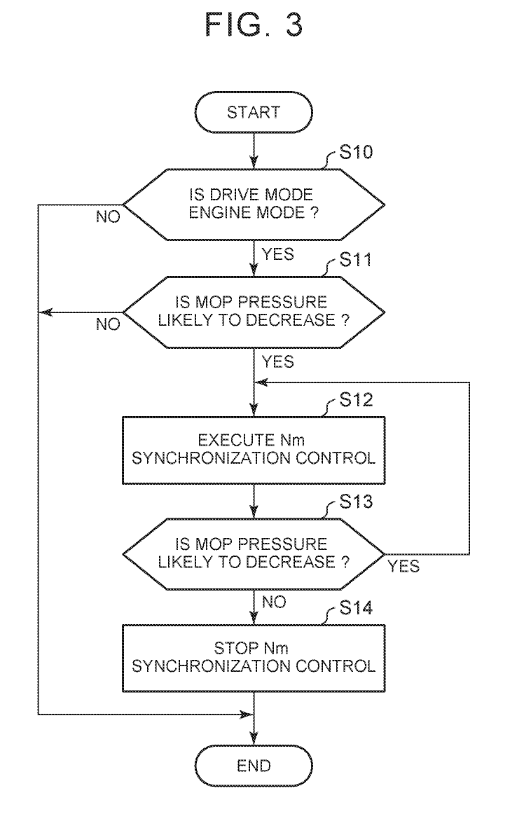

FIG. 3 is a flowchart that shows a procedure that is executed by the ECU 100. This flowchart is repeatedly executed at predetermined intervals.

In step (hereinafter, step is abbreviated as “S”) 10, the ECU 100 determines whether the drive mode is the engine mode (that is, the mode in which the vehicle travels by using the power of the engine 10 while releasing the N/C clutch K2). When the drive mode is not the engine mode (NO in S10), the ECU 100 ends the process.

When the drive mode is the engine mode (YES in S10), the ECU 100 determines in S11 whether the MOP pressure is likely to decrease to a hydraulic pressure lower than the release hydraulic pressure P1 of the clutch K2 on the basis of the vehicle state.

The ECU 100 according to the present embodiment determines that the MOP pressure is likely to decrease to a hydraulic pressure lower than the release hydraulic pressure P1 of the clutch K2 when at least any one of the following conditions (a) and (b) is satisfied. (a) The user has suddenly braked the vehicle. (b) The lockup clutch 34 is controlled to the released state and there occurs a stuck-on failure in the lockup clutch 34 (failure that the lockup clutch 34 is not released even in an attempt to be released, and is fixed to the engaged state) in a state where the turbine rotation speed Nt is lower than the engine rotation speed Ne.

Whether the user has suddenly braked the vehicle may be determined on the basis of, for example, the brake pedal operation amount. That is, when the brake pedal operation amount rapidly increases within a predetermined time and exceeds a threshold amount, it may be determined that the user has rapidly braked the vehicle. Whether the lockup clutch 34 is in a stuck-on failure may be determined on the basis of, for example, a slip amount (a rotation speed difference between the pump impeller 31 and the turbine runner 32) of the torque converter 30. That is, when the slip amount of the torque converter 30 is smaller than the threshold amount although the engine 10 is operated such that the lockup clutch 34 is controlled to be released, it may be determined that the lockup clutch 34 is in a stuck-on failure.

When the MOP pressure is not likely to decrease to a hydraulic pressure lower than the release hydraulic pressure P1 of the clutch K2 (NO in S11), the ECU 100 ends the process.

When the MOP pressure is likely to decrease to a hydraulic pressure lower than the release hydraulic pressure P1 of the clutch K2 (YES in S11), the ECU 100 executes the above-described Nm synchronization control in S12. That is, the ECU 100 executes feedback control over the torque of the MG 20 such that the MG rotation speed Nm is synchronous with the engine rotation speed Ne (the rotation speed of the rotary shaft 35).

During execution of Nm synchronization control, the ECU 100 determines in S13 again whether the MOP pressure is likely to decrease to a hydraulic pressure lower than the release hydraulic pressure P1 of the clutch K2. When the MOP pressure is likely to decrease to a hydraulic pressure lower than the release hydraulic pressure P1 of the clutch K2 (YES in S13), that is, when sudden brake or the stuck-on failure of the lockup clutch 34 is continuing, the ECU 100 returns the process to S12, and continues execution of Nm synchronization control.

When the MOP pressure is not likely to decrease to a hydraulic pressure lower than the release hydraulic pressure P1 of the clutch K2 (NO in S13), the ECU 100 advances the process to S14, and stops Nm synchronization control.

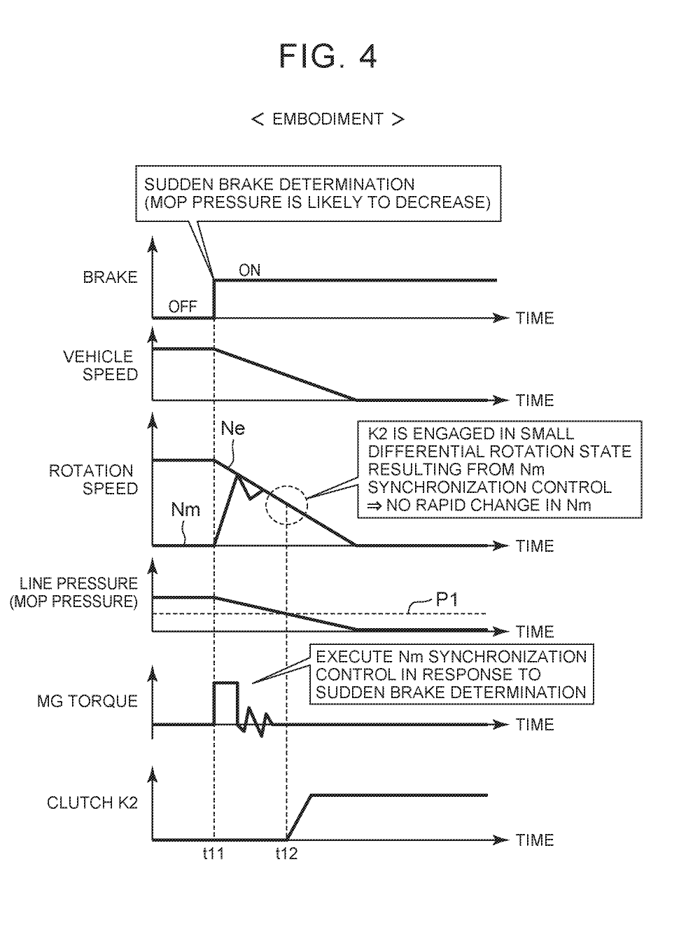

FIG. 4 is a timing chart that shows an example of changes in MG rotation speed Nm, and the like, in the case where the user has suddenly braked the vehicle in engine mode.

Before time t11, the vehicle 1 is traveling in engine mode. That is, the K2 pressure is controlled to a hydraulic pressure higher than or equal to the release hydraulic pressure P1 of the clutch K2, and the clutch K2 is released. The clutch K0 is engaged, and the engine 10 is connected to the drive wheels 50.

When the user has suddenly braked the vehicle at time t11, the engine rotation speed Ne rapidly decreases with a rapid decrease in vehicle speed, and at last the engine 10 stalls.

The ECU 100 starts executing Nm synchronization control at time t11, at which the vehicle has been suddenly braked, in preparation for engine stall due to such sudden brake. Thus, the MG rotation speed Nm is synchronized with the engine rotation speed Ne.

When the line pressure (MOP pressure) decreases to a hydraulic pressure lower than the release hydraulic pressure P1 of the clutch K2 at time t12 thereafter, the K2 pressure that uses the line pressure as the source pressure also decreases to a hydraulic pressure lower than the release hydraulic pressure P1, so the clutch K2 is unexpectedly engaged. However, when the clutch K2 is engaged, the difference between the MG rotation speed Nm and the engine rotation speed Ne has already become small through Nm synchronization control. Therefore, the MG rotation speed Nm does not rapidly change at the time when the clutch K2 is engaged, so shock is prevented or reduced.

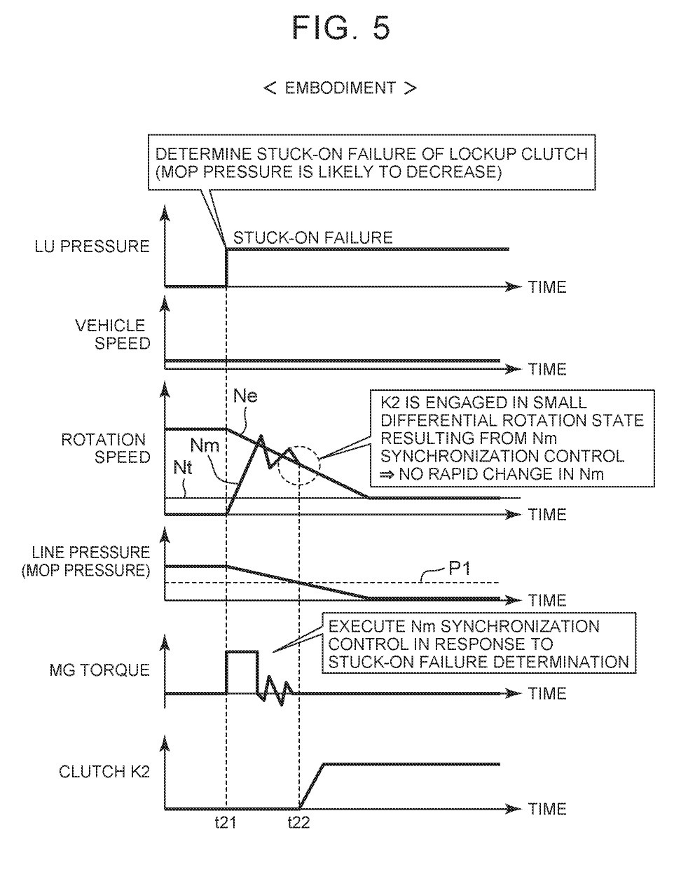

FIG. 5 is a timing chart that shows an example of changes in MG rotation speed Nm, and the like, in the case where there occurs a stuck-on failure of the lockup clutch 34 in engine mode.

Before time t21, the vehicle 1 is traveling at a low vehicle speed in engine mode in a state where the lockup clutch 34 is released. At this time, the turbine rotation speed Nt is a low value commensurate with a vehicle speed; however, the engine rotation speed Ne is kept at a value higher than the turbine rotation speed Nt because of a slip of the torque converter 30.

Incidentally, when there occurs a stuck-on failure of the lockup clutch 34 at time t21, the engine rotation speed Ne is influenced by the turbine rotation speed Nt and rapidly decreases, so the engine 10 stalls.

The ECU 100 starts executing Nm synchronization control at time t21, at which there occurs a stuck-on failure of the lockup clutch 34, in preparation for engine stall due to such a stuck-on failure of the lockup clutch 34. Thus, the MG rotation speed Nm is synchronized with the engine rotation speed Ne.

When the line pressure (MOP pressure) decreases to a hydraulic pressure lower than the release hydraulic pressure P1 of the clutch K2 as a result of a decrease in the engine rotation speed Ne at time t22 thereafter, the K2 pressure also decreases to the hydraulic pressure lower than the release hydraulic pressure P1, so the clutch K2 is unexpectedly engaged. However, when the clutch K2 is engaged, the difference between the MG rotation speed Nm and the engine rotation speed Ne has already become small through Nm synchronization control. Therefore, as in the case described with reference to FIG. 4, the MG rotation speed Nm does not rapidly change at the time when the clutch K2 is engaged, so shock is prevented or reduced.

As described above, the ECU 100 according to the present embodiment determines whether the MOP pressure is likely to decrease to a hydraulic pressure lower than the release hydraulic pressure P1 of the clutch K2 in engine mode in which the vehicle travels by using the power of the engine 10 while releasing the N/C clutch K2. When the ECU 100 determines that the MOP pressure is likely to decrease to a hydraulic pressure lower than the release hydraulic pressure P1 of the clutch K2, the ECU 100 executes Nm synchronization control for synchronizing the MG rotation speed Nm with the rotation speed of the rotary shaft 35. Thus, if the clutch K2 is unexpectedly engaged as a result of a decrease in the MOP pressure thereafter, the MG rotation speed Nm does not rapidly change because the difference between the MG rotation speed Nm and the engine rotation speed Ne has already become extremely small through Nm synchronization control. Therefore, shock due to engagement of the clutch K2 is reduced or prevented.

In the above-described embodiment, in the process of S11 in FIG. 3, in the case of at least any one of the case where the user has suddenly braked the vehicle and the case where there occurs a stuck-on failure of the lockup clutch 34, it is determined that the MOP pressure is likely to decrease to a hydraulic pressure lower than the release hydraulic pressure P1.

However, the condition to determine whether the MOP pressure is likely to decrease to a hydraulic pressure lower than the release hydraulic pressure P1 is not limited to these conditions. For example, in the case where a hydraulic pressure sensor that detects the MOP pressure or the line pressure is provided, when a value detected by the hydraulic pressure sensor has decreased to a hydraulic pressure lower than a threshold pressure that is higher by a predetermined value than the release hydraulic pressure P1, it may be determined that the MOP pressure is likely to decrease to a hydraulic pressure lower than the release hydraulic pressure P1, and Nm synchronization control may be executed.

The embodiment described above is illustrative and not restrictive in all respects. The scope of the present disclosure is defined by the appended claims rather than the above description. The scope of the present disclosure is intended to encompass all modifications within the scope of the appended claims and equivalents thereof.

What is claimed is:

1. A vehicle comprising:
an engine;
a motor generator connected to a power transmission path between the engine and a drive wheel;
an oil pump connected to a rotary shaft provided in the power transmission path between the engine and the drive wheel, the oil pump being configured to be driven by rotation of the rotary shaft;
a motor disconnect clutch provided between the motor generator and the power transmission path between the engine and the drive wheel, the motor disconnect clutch being configured to operate by using hydraulic pressure that is supplied from the oil pump, the motor disconnect clutch being configured to be set to an engaged state when the hydraulic pressure that is supplied from the oil pump is lower than a predetermined release hydraulic pressure and be set to a released state when the hydraulic pressure that is supplied from the oil pump is higher than or equal to the release hydraulic pressure; and
a controller configured to, when the hydraulic pressure output from the oil pump is likely to decrease to a hydraulic pressure lower than the release hydraulic pressure in an engine mode in which the vehicle travels by using power of the engine during execution of control for releasing the motor disconnect clutch, execute synchronization control for synchronizing a rotation speed of the motor generator with a rotation speed of the rotary shaft.

2. The vehicle according to claim 1, wherein
the controller is configured to, when a brake operation amount of a user exceeds a threshold amount during execution of the control for releasing the motor disconnect clutch, determine that the hydraulic pressure output from the oil pump is likely to decrease to a hydraulic pressure lower than the release hydraulic pressure and execute the synchronization control.

3. The vehicle according to claim 1, further comprising:
an automatic transmission provided between the engine and the drive wheel; and
a torque converter including
a pump impeller connected to the engine,
a turbine runner connected to an input shaft of the automatic transmission, and
a lockup clutch, wherein
the rotary shaft is provided in a power transmission path that connects the engine to the torque converter, and
the controller is configured to, when there occurs a stuck-on failure during execution of the control for releasing the motor disconnect clutch, determine that the hydraulic pressure output from the oil pump is likely to decrease to a hydraulic pressure lower than the release hydraulic pressure and execute the synchronization control, and
the stuck-on failure is a state where the lockup clutch is engaged in a state where the lockup clutch is controlled to a released state and a rotation speed of the turbine runner is lower than a rotation speed of the engine.

4. The vehicle according to claim 1, further comprising:
a hydraulic pressure sensor configured to detect the hydraulic pressure output from the oil pump, wherein
the controller is configured to, when a value detected by the hydraulic pressure sensor has decreased to a hydraulic pressure lower than a threshold pressure higher by a predetermined value than the release hydraulic pressure during execution of the control for releasing the motor disconnect clutch, determine that the hydraulic pressure output from the oil pump is likely to decrease to a hydraulic pressure lower than the release hydraulic pressure and execute the synchronization control.
